(19) United States
(12) Patent Application Publication
(10) Pub. No.: US 2015/0118577 A1
(43) Pub. Date: Apr. 30, 2015

(54) LITHIUM SECONDARY BATTERY

(71) Applicant: NEC Corporation, Tokyo (JP)

(72) Inventors: Yuukou Katou, Tokyo (JP); Takehiro Noguchi, Tokyo (JP); Hideaki Sasaki, Tokyo (JP); Makiko Takahashi, Tokyo (JP); Shinsaku Saitho, Tokyo (JP)

(21) Appl. No.: 14/397,337

(22) PCT Filed: Apr. 22, 2013
(86) PCT No.: PCT/JP2013/061812

§ 371 Date: Oct. 27, 2014

(30) Foreign Application Priority Data
Apr. 27, 2012 (JP) 2012-104161

(51) Int. Cl. H01M 10/0569; H01M 4/58; H01M 4/505; H01M 10/0525; H01M 4/1315

(52) U.S. Cl. CPC H01M 10/0569; H01M 10/0525; H01M 4/1315; H01M 4/505; H01M 4/5825; H01M 2004/028
USPC 429/334

(57) ABSTRACT

An embodiment of the present invention relates to a lithium secondary battery comprising: a positive electrode comprising a positive electrode active material; and an electrolytic solution comprising a nonaqueous electrolytic solvent, wherein the positive electrode active material operates at a potential of 4.5 V or more versus lithium, and the electrolytic solution comprises: the nonaqueous electrolytic solvent comprising a fluorine-containing phosphate ester represented by a given formula; and a cyclic sulfonate ester represented by a given formula.

### TECHNICAL FIELD

The present invention relates to a lithium secondary battery.

### BACKGROUND ART

Since a lithium secondary battery has a small size and large capacity, it is widely utilized for applications such as a portable electric device and a personal computer. However, while a rapid development of portable electric devices or the use for electric vehicles have been realized in recent years, further improvement in energy density has been an important technical subject.

There are several methods to increase energy density of a lithium secondary battery. Among them, it is effective to increase an operation potential of the battery. In a lithium secondary battery using conventional cobalt acid lithium and manganese acid lithium as a positive electrode active material, each operation potential is 4 V class (average operation potential=3.6 to 3.8 V: versus lithium potential). This operation voltage is determined by oxidation-reduction reaction of a Co ion or Mn ion (Co³⁺←→Co⁴⁺ or Mn³⁺←→Mn⁴⁺).

By contrast, it is known that an operation potential of 5 V class can be achieved by, for example, using a spinel compound in which Mn of manganese acid lithium is replaced with Ni or Co, Fe, Cu, Cr and others, as an active material. Specifically, as in Patent Literature 1, it is known that a spinel compound such as LiNi_{0.5}Mn_{0.5}O₄ shows a potential plateau in the area of 4.5 V or more. In such a spinel compound, Mn is present in the quadrivalent state, and the operation potential is determined by oxidation-reduction of Ni²⁺←→Ni⁴⁺ instead of oxidation-reduction of Mn³⁺←→Mn⁴⁺.

LiNi_{0.5}Mn_{0.5}O₄ has a capacity of 130 mAh/g or more, and the average operation voltage is 4.6 V or more versus lithium metal. Although its capacity is smaller than that of LiCoO₂, energy density of the battery is higher than that of LiCoO₂. Furthermore, a spinel type lithium manganese oxide has a three-dimensional lithium diffusion path and also has advantages such as excellent thermodynamic stability and easy synthesis. For these reasons, LiNi_{0.5}Mn_{1.5}O₄ holds promise as a future positive electrode material.

As for an electrolytic solution used in a lithium secondary battery, the examples described in the following literatures are proposed.

Patent Literature 2 discloses an electrolytic solution that contains a phosphate ester and a compound having a sulfone structure. According to this literature, it is disclosed that swelling deformation of the battery exterior during high temperature storage can be prevented in a lithium secondary battery using a 4 V class electrode.

Patent Literature 3 discloses a nonaqueous electrolytic solution for battery, which contains: an unsaturated phosphate ester compound as (A) component; at least one compound selected from the group consisting of a sulfite ester compound, a sulfonate ester compound, an imide salt compound of an alkali metal, a fluorosilane compound, an organic disilane compound and an organic disiloxane compound as (B) component; an organic solvent as (C) component; and an electrolyte salt as (D) component. In addition, the case where an unsaturated phosphate compound is halogenated is also disclosed. According to this literature, it is disclosed that less inner resistance and high electric capacity can be maintained during long-term use in a nonaqueous electrolyte secondary battery which has a negative electrode manufactured comprising a highly crystalline carbon material such as graphite as an active material, and a polymer carboxylic acid compound as a binder.

In Patent Literature 4, a secondary battery that has an electrolytic solution containing a fluorine-containing phosphate ester is disclosed.

In Patent Literatures 5 and 6, it is disclosed that a cyclic sulfonate ester as an additive agent is added to an electrolytic solution in order to improve storage characteristics at a high temperature.

Patent Literature 7 discloses use of an electrolytic solution containing a cyclic sulfonate ester derivative in a battery using a 5 V class positive electrode active material.

### CITATION LIST

### Patent Literature

Patent Literature 1: Japanese Patent Laid-Open No. 2009-123707
Patent Literature 2: Japanese Patent Laid-Open No. 2008-41635
Patent Literature 3: Japanese Patent Laid-Open No. 2011-124039
Patent Literature 4: Japanese Patent Laid-Open No. 2008-021560
Patent Literature 5: Japanese Patent Laid-Open No. 2005-149750
Patent Literature 6: Japanese Patent Laid-Open No. 2005-251677
Patent Literature 7: Japanese Patent Laid-Open No. 2006-344390

### SUMMARY OF INVENTION

### Technical Problem

However, in the case of the battery using a positive electrode material having high discharge potential such as LiNi_{0.5}Mn_{0.5}O₄ as an active material, the potential becomes still higher than the case where a positive electrode uses LiCoO₂, LiMn₂O₄ and the like, and thus decomposition reaction of the electrolytic solution easily occurs in a contact portion with the positive electrode. Therefore, there was a case where volume expansion and a decrease in capacity due to gas generation associated with charge-and-discharge cycles became remarkable. In particular, degradation of the electrolytic solution tends to become remarkable with increasing temperature, and there was a problem of a life improvement during operation at a high temperature such as 40° C. or more.

Thus, an object of the present invention is to provide a lithium secondary battery that has high energy density by containing a positive electrode active material operating at a potential of 4.5 V or more versus lithium and that can achieve excellent cycle characteristics.

### Solution to Problem

An embodiment of the present invention is a lithium secondary battery comprising:

a positive electrode comprising a positive electrode active material; and

an electrolytic solution comprising a nonaqueous electrolytic solvent,

wherein

the positive electrode active material operates at a potential of 4.5 V or more versus lithium, and

the electrolytic solution comprises: the nonaqueous electrolytic solvent containing a fluorine-containing phosphate ester represented by the following formula (1); and a cyclic sulfonate ester represented by the following formula (2).

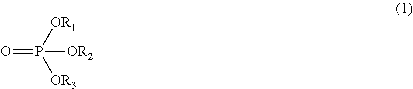

wherein R₁, R₂ and R₃ are each independently substituted or unsubstituted alkyl group, and at least one of R₁, R₂ and R₃ is fluorine-containing alkyl group.

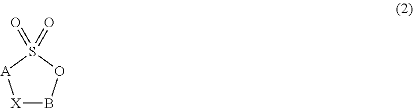

wherein A and B are each independently alkylene group or fluoroalkylene group, and X is a C—C single bond or —OSO₂— group.

### Advantageous Effects of Invention

According to the present invention, a secondary battery having excellent cycle characteristics can be provided, in which even the positive electrode active material operating at a potential of 4.5 V or more versus lithium is used.

### BRIEF DESCRIPTION OF DRAWING

FIG. 1 is an example of a sectional view of the secondary battery according to an embodiment of the present invention.

### DESCRIPTION OF EMBODIMENTS

The lithium secondary battery of an embodiment of the present invention has: a positive electrode containing a positive electrode active material; and an electrolytic solution containing a nonaqueous electrolytic solvent. The above-mentioned positive electrode active material operates at a potential of 4.5 V or more versus lithium. The above-mentioned electrolytic solution contains; a nonaqueous electrolytic solvent containing a fluorine-containing phosphate ester represented by the formula (1); and a cyclic sulfonate ester represented by the formula (2). In the electrolytic solution, oxidation resistance is improved by containing the fluorine-containing phosphate ester, and reaction of the electrolytic solution is suppressed and volume expansion is suppressed by a coating film formed from the cyclic sulfonate ester. Furthermore, the combined use of the fluorine-containing phosphate ester represented by the formula (1) and the cyclic sulfonate ester represented by the formula (2) improves cycle characteristics much more than the case where either one is used alone. The present embodiment exerts a prominent effect in the lithium secondary battery that uses a high potential positive electrode active material, especially a positive electrode active material operating at a potential of 4.5 V or more versus lithium, in which decomposition of the electrolytic solution tends to be a large problem. The term “cyclic sulfonate ester” described herein means both “cyclic monosulfonate ester” and “cyclic disulfonate ester” as long as there is no explicit statement.

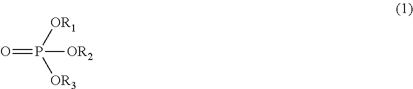

wherein R₁, R₂ and R₃ are each independently substituted or unsubstituted alkyl group, and at least one of R₁, R₂ and R₃ is fluorine-containing alkyl group.

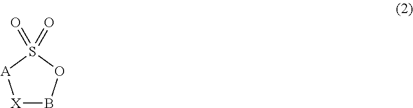

wherein A and B are each independently alkylene group or fluoroalkylene group, and X is a C—C single bond or —OSO₂— group.

### (Electrolytic Solution)

The electrolytic solution contains a support salt, a nonaqueous electrolytic solvent containing the fluorine-containing phosphate ester represented by the above-mentioned formula (1), and the cyclic sulfonate ester represented by the above-mentioned formula (2).

### (Fluorine-Containing Phosphate Ester)

The content of the fluorine-containing phosphate ester contained in the nonaqueous electrolytic solvent is not particularly limited, but 5 volume % or more and 95 volume % or less in the nonaqueous electrolytic solvent is preferable. When the content of the fluorine-containing phosphate ester in the nonaqueous electrolytic solvent is 5 volume % or more, an effect of enhancing voltage endurance is more improved. Meanwhile, when the content of the fluorine-containing phosphate ester in the nonaqueous electrolytic solvent is 95 volume % or less, ion conductivity of the electrolytic solution is increased to provide a better charge-discharge rate of the battery. Moreover, the content of the fluorine-containing phosphate ester in the nonaqueous electrolytic solvent is preferably 10 volume % or more. Furthermore, the content of the fluorine-containing phosphate ester in the nonaqueous electrolytic solvent is more preferably 70 volume % or less, still more preferably 60 volume % or less, especially preferably 59 volume % or less, and more especially preferably 55 volume % or less.

In the fluorine-containing phosphate represented by the formula (1), R₁, R₂ and R₃ are each independently substituted or unsubstituted alkyl group, and at least one of R₁, R₂ and R₃ is fluorine-containing alkyl group. The fluorine-containing alkyl group is alkyl group that has at least one fluorine atom. It is preferable that the numbers of carbon atoms of the alkyl groups R₁, R₂ and R₃ be each independently 1 or more and 4 or less, and 1 or more and 3 or less is more preferable. This is because when the number of carbon atoms of the alkyl group is 4 or less, an increase in viscosity of an electrolytic solution is suppressed to facilitate permeation of the electrolytic solution into pores of the electrode or the separator, and ionic conductivity is enhanced, which leads to improve a current value in charge-discharge characteristics of the battery.

Furthermore, in the formula (1), all of R₁, R₂ and R₃ are preferably fluorine-containing alkyl groups.

At least one of R₁, R₂ and R₃ is preferably fluorine-containing alkyl group in which 50% or more of hydrogen atoms contained in the corresponding unsubstituted alkyl group are replaced with fluorine atoms. In addition, it is more preferable that all of R₁, R₂ and R₃ are fluorine-containing alkyl groups, and that R₁, R₂ and R₃ are fluorine-containing alkyl groups in which 50% or more of hydrogen atoms contained in the corresponding unsubstituted alkyl group are replaced with fluorine atoms. This is because the large content of fluorine atom improves voltage endurance, and thus even when there is used a positive electrode active material operating at a potential of 4.5 V or more versus lithium, degradation of the battery capacity after cycles is more reduced. Furthermore, it is more preferable that the ratio of fluorine atoms in the substituents (including hydrogen atoms) of the fluorine-containing alkyl group is 55% or more.

R₁ to R₃ may have a substituent other than a fluorine atom, and the substituent includes at least one selected from the group consisting of amino group, carboxy group, hydroxy group, cyano group and halogen atom (for example, a chlorine atom and a bromine atom). The above-mentioned number of carbon atoms is described in the conception including substituents.

Examples of the fluorine-containing phosphate ester include tris(trifluoromethyl)phosphate, tris(trifluoroethyl)phosphate, tris(tetrafluoropropyl)phosphate, tris(pentafluoropropyl)phosphate, tris(heptafluorobutyl)phosphate, and tris(octafluoropentyl)phosphate. In addition, examples of the fluorine-containing phosphate ester include trifluoroethyl dimethyl phosphate, bis(trifluoroethyl) methyl phosphate, bistrifluoroethyl ethyl phosphate, pentafluoropropyl dimethyl phosphate, heptafluorobutyl dimethyl phosphate, trifluoroethyl methyl ethyl phosphate, pentafluoropropyl methyl ethyl phosphate, heptafluorobutyl methyl ethyl phosphate, trifluoroethyl methyl propyl phosphate, pentafluoropropyl methyl propyl phosphate, heptafluorobutyl methyl propyl phosphate, trifluoroethyl methyl butyl phosphate, pentafluoropropyl methyl butyl phosphate, heptafluorobutyl methyl butyl phosphate, tri fluoroethyl diethyl phosphate, pentafluoropropyl diethyl phosphate, heptafluorobutyl diethyl phosphate, trifluoroethyl ethyl propyl phosphate, pentafluoropropyl ethyl propyl phosphate, heptafluorobutyl ethyl propyl phosphate, trifluoroethyl ethyl butyl phosphate, pentafluoropropyl ethyl butyl phosphate, heptafluorobutyl ethyl butyl phosphate, trifluoroethyl dipropyl phosphate, pentafluoropropyl dipropyl phosphate, heptafluorobutyl dipropyl phosphate, trifluoroethyl propyl butyl phosphate, pentafluoropropyl propyl butyl phosphate, heptafluorobutyl propyl butyl phosphate, trifluoroethyl dibutyl phosphate, pentafluoropropyl dibutyl phosphate, and heptafluorobutyl dibutyl phosphate. Examples of tris(tetrafluoropropyl)phosphate include tris(2,2,3,3-tetrafluoropropyl)phosphate. Examples of tris(pentafluoropropyl)phosphate include tris(2,2,3,3,3-pentafluoropropyl)phosphate. Examples of tris(trifluoroethyl)phosphate include tris(2,2,2-trifluoroethyl)phosphate (hereinafter also referred to as PTTFE). Examples of tris(heptafluorobutyl)phosphate include tris(1H,1H-heptafluorobutyl)phosphate. Examples of tris(octafluoropentyl)phosphate include tris(1H,1H,5H-octafluoropentyl)phosphate. Among these, tris(2,2,2-trifluoroethyl)phosphate represented by the following formula (3) is preferred because of its high effect of suppressing decomposition of the electrolytic solution at a high potential. The fluorine-containing phosphate ester can be used singly or in combinations of two or more.

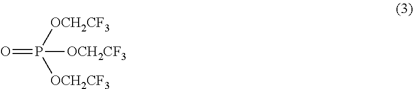

### (Cyclic Sulfonate Ester)

In the cyclic sulfonate ester represented by the formula (2), A and B each independently denote alkylene group or fluorinated alkylene group, and X denotes a C—C single bond or —OSO₂— group. In the formula (2), the number of carbon atoms of the alkylene group is, for example, 1 to 8, preferably 1 to 6, and more preferably 1 to 4.

The fluorinated alkylene group refers to substituted alkylene group having a structure in which at least one hydrogen atom in unsubstituted alkylene group is replaced with a fluorine atom. In the formula (2), the number of carbon atoms of the fluorinated alkylene group is, for example, 1 to 8, preferably 1 to 6, and more preferably 1 to 4.

In addition, the —OSO₂— group may be arranged in either direction.

In the formula (2), when X is a single bond, the cyclic sulfonate ester is a cyclic monosulfonate ester. The cyclic monosulfonate ester is preferably a compound represented by the following formula (4).

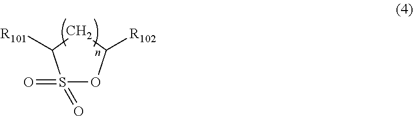

wherein R₁₀₁ and R₁₀₂ each independently denote a hydrogen atom, a fluorine atom, or alkyl group having 1 to 4 carbon atoms; and n is 0, 1, 2, 3 or 4.

In the formula (2), when X is —OSO₂— group, the cyclic sulfonate ester is a cyclic disulfonate ester. The cyclic disulfonate ester is preferably a compound represented by the following formula (5).

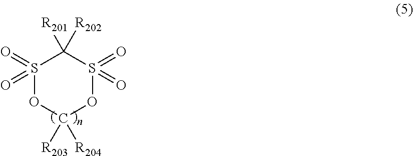

wherein R₂₀₁ to R₂₀₄ each independently denote a hydrogen atom, a fluorine atom, or alkyl group having 1 to 4 carbon atoms; n is 1, 2, 3 or 4; and when n is 2, 3 or 4, R₂₀₃ in n-occurrences may be the same or different from each other, and R₂₀₄ in n-occurrences may be the same or different from each other.

For example, the cyclic sulfonate ester includes: monosulfonate esters (the case where X in the formula (2) is a single bond) such as 1,3-propanesultone, 1,2-propanesultone, 1,4-butanesultone, 1,2-butanesultone, 1,3-butanesultone, 2,4-butanesultone, and 1,3-pentanesultone; disulfonate esters (the case where X in the formula (2) is —OSO₂— group) such as methylene methane disulfonate ester (1,5,2,4-dioxadithiane-2,2,4,4-tetraoxide), and ethylene methane disulfonate ester. Among these, 1,3-propanesultone, 1,4-butanesultone and methylene methane disulfonate ester are preferable from viewpoints of a coat formation effect, availability and cost.

The content of the cyclic sulfonate ester in the electrolytic solution is preferably 0.01 to 10 mass %, and 0.1 to 5 mass % is more preferable. When the content of the cyclic sulfonate ester is 0.01 mass % or more, a coating can be more effectively formed on the surface of the positive electrode, and decomposition of the electrolytic solution can be suppressed.

It is preferable that the electrolytic solution further contain a cyclic carbonate and/or a chain carbonate as a nonaqueous electrolytic solvent in addition to the above-mentioned fluorine-containing phosphate ester and cyclic sulfonate ester.

Since the cyclic carbonate or the chain carbonate has a large specific dielectric constant, addition of these compounds improves dissociation characteristics of a support salt and easily provides sufficient electrical conductivity. Moreover, since the cyclic carbonate and chain carbonate have high voltage endurance and electrical conductivity, they are suitable for blending with a fluorine-containing phosphate. Furthermore, by selecting a material that is effective in lowering viscosity of the electrolytic solution, it is also possible to increase ionic mobility in the electrolytic solution.

The cyclic carbonate is not especially limited but includes, for example, ethylene carbonate (EC), propylene carbonate (PC), butylene carbonate (BC), and vinylene carbonate (VC). Moreover, the cyclic carbonate includes a fluorine-containing cyclic carbonate. Examples of the fluorine-containing cyclic carbonate include compounds in which some or all of hydrogen atoms in ethylene carbonate (EC), propylene carbonate (PC), butylene carbonate (BC), and vinylene carbonate (VC) are replaced with fluorine atoms. More specifically for example, 4-fluoro-1,3-dioxolan-2-one, (cis or trans) 4,5-difluoro-1,3-dioxolan-2-one, 4,4-difluoro-1,3-dioxolan-2-one and 4-fluoro-5-methyl-1,3-dioxolan-2-one and the like may be used as the fluorine-containing cyclic carbonate. Among the above-mentioned cyclic carbonate, from viewpoints of voltage endurance and conductivity, ethylene carbonate, propylene carbonate, and a partially fluorinated compound thereof are preferable, and ethylene carbonate is more preferable. The cyclic carbonate can be used singly or in combinations of two or more.

From a viewpoint of effects of increasing the dissociation degree of the support salt and improving electrical conductivity of the electrolytic solution, the content of the cyclic carbonate in the nonaqueous electrolytic solvent is preferably 0.1 volume % or more, more preferably 5 volume % or more, still more preferably 10 volume % or more, and especially preferably 15 volume % or more. Moreover, from the similar viewpoint, the content of the cyclic carbonate in the nonaqueous electrolytic solvent is preferably 70 volume % or less, more preferably 50 volume % or less, and still more preferably 40 volume % or less.

The chain carbonate is not particularly limited, but includes, for example, dimethyl carbonate (DMC), ethyl methyl carbonate (EMC), diethyl carbonate (DEC), and dipropyl carbonate (DPC). Moreover, the chain carbonate includes a fluorinated chain carbonate. Examples of the fluorinated chain carbonate include compounds having structures in which some or all of hydrogen atoms of ethyl methyl carbonate (EMC), dimethyl carbonate (DMC), diethyl carbonate (DEC), dipropyl carbonate (DPC) and the like are replaced with fluorine atoms. More specifically, examples of the fluorinated chain carbonate include bis(fluoroethyl)carbonate, 3-fluoropropyl methyl carbonate, 3,3,3-trifluoropropyl methyl carbonate, 2,2,2-trifluoroethyl methyl carbonate, 2,2,2-trifluoroethyl ethyl carbonate, monofluoromethyl methyl carbonate, methyl 2,2,3,3-tetrafluoropropyl carbonate, ethyl 2,2,3,3-tetrafluoropropyl carbonate, bis(2,2,3,3-tetrafluoropropyl)carbonate, bis(2,2,2trifluoroethyl)carbonate, 1-monofluoroethyl ethyl carbonate, 1-monofluoroethyl methyl carbonate, 2-monofluoroethyl methyl carbonate, bis(1-monofluoroethyl)carbonate, bis(2-monofluoroethyl)carbonate, bis(monofluoromethyl)carbonate. Among them, from viewpoints of voltage endurance and electrical conductivity, dimethyl carbonate, 2,2,2-trifluoroethyl methyl carbonate, monofluoromethyl methyl carbonate, methyl 2,2,3,3-tetrafluoropropyl carbonate and the like are preferable. The chain carbonate can be used singly or in combinations of two or more.

The chain carbonate has an advantage of low viscosity when the number of carbon atoms of the substituent added to a “—OCOO—” structure is small. On the other hand, when the number of carbon atoms is too large, the viscosity of the electrolytic solution may become high, resulting in a decrease of conductivity of Li ion. For this reason, the total number of carbon atoms of two substituents added to a “—OCOO-” structure of the chain carbonate is preferably 2 or more and 6 or less. Moreover, when a substituent added to a “−0000-” structure contains a fluorine atom, oxidation resistance of the electrolytic solution is improved. For this reason, the chain carbonate is preferably a fluorinated chain carbonate represented by the following formula (6).

CₙH₂ₙ₊₁₋ₗFₗ—OCOO—CₘH₂ₘ₊₁₋ₖFₖ (6)

wherein n is 1, 2 or 3; m is 1, 2 or 3; 1 is any integer from 0 to 2n+1; k is any integer from 0 to 2m+1; and at least one of l and k is an integer of 1 or more.

In the fluorinated chain carbonate shown by the formula (6), when the amount of fluorine substation is small, the fluorinated chain carbonate may react with the positive electrode of a high potential, and thereby a capacity retention ratio of the battery may fall or gas may be generated. On the other hand, if the amount of fluorine substitution is too high, compatibility of the chain carbonate with the other solvents may be decreased, or a boiling point of the chain carbonate may be decreased. For these reasons, the amount of fluorine substitution is preferably 1% or more and 90% or less, more preferably 5% or more and 85% or less, and still more preferably 10% or more and 80% or less. This means that, it is preferable that 1, m and n of the formula (6) satisfy the following formula.

0.01≦(l+k)/(2n+2m+2)≦0.9

The chain carbonate is effective in lowering viscosity of the electrolytic solution, and can raise electrical conductivity of the electrolytic solution. In view of this, the content of the chain carbonate in the nonaqueous electrolytic solvent is preferably 5 volume % or more, more preferably 10 volume % or more, and still more preferably 15 volume % or more. In addition, the content of the chain carbonate in the nonaqueous electrolytic solvent is preferably 90 volume % or less, more preferably 80 volume % or less, and still more preferably 70 volume % or less.

The content of the fluorinated chain carbonate is not particularly limited, but 0.1 volume % or more and 70 volume % or less in the nonaqueous electrolytic solvent is preferable. When the content of the fluorinated chain carbonate in the nonaqueous electrolytic solvent is 0.1 volume % or more, viscosity of the electrolytic solution can be lowered to improve electrical conductivity. In addition, an effect of improving oxidation resistance is acquired. Meanwhile, when the content of the fluorinated chain carbonate in the nonaqueous electrolytic solvent is 70 volume % or less, it is possible to keep high electrical conductivity of the electrolytic solution. Moreover, the content of the fluorinated chain carbonate in the nonaqueous electrolytic solvent is more preferably 1 volume % or more, still more preferably 5 volume % or more, and especially preferably 10 volume % or more. The content of the fluorinated chain carbonate in the nonaqueous electrolytic solvent is more preferably 65 volume % or less, still more preferably 60 volume % or less, and especially preferably 55 volume % or less.

In addition to the fluorine-containing phosphate ester, the nonaqueous electrolytic solvent can contain a carboxylate ester.

The carboxylate ester is not especially limited but includes, for example, ethyl acetate, methyl propionate, ethyl formate, ethyl propionate, methyl butyrate, ethyl butyrate, methyl acetate, and methyl formate. Moreover, the carboxylate ester includes a fluorine-containing carboxylate ester. Examples of the fluorine-containing carboxylate ester include a compound having a structure in which some or all of hydrogen atoms of ethyl acetate, methyl propionate, ethyl formate, ethyl propionate, methyl butyrate, ethyl butyrate, methyl acetate or methyl formate are replaced with fluorine atoms. Specifically, examples of the fluorinated carboxylate ester include ethyl pentafluoropropionate, ethyl 3,3,3-trifluoropropionate, methyl 2,2,3,3-tetrafluoropropionate, 2,2-difluoroethyl acetate, methyl heptafluoroisobutyrate, methyl 2,3,3,3-tetrafluoropropionate, methyl pentafluoropropionate, methyl 2-(trifluoromethyl)-3,3,3-trifluoropropionate, ethyl heptafluorobutyrate, methyl 3,3,3-trifluoropropionate, 2,2,2-trifluoroethyl acetate, isopropyl trifluoroacetate, tert-butyl trifluoroacetate, ethyl 4,4,4-trifluorobutyrate, methyl 4,4,4-trifluorobutyrate, butyl 2,2-difluoroacetate, ethyl difluoroacetate, n-butyl trifluoroacetate, 2,2,3,3-tetrafluoropropyl acetate, ethyl 3-(trifluoromethyl)butyrate, methyl tetrafluoro-2-(methoxy)propionate, 3,3,3-trifluoropropyl 3,3,3-trifluoropropionate, methyl difluoroacetate, 2,2,3,3-tetrafluoropropyl trifluoroacetate, 1H,1H-heptafluorobutyl acetate, methyl heptafluorobutyrate and ethyl trifluoroacetate and the like. Among these, from the viewpoints of voltage endurance, a boiling point and the like, ethyl propionate, methyl acetate, methyl 2,2,3,3-tetrafluoropropionate, 2,2,3,3-tetrafluoropropyl trifluoroacetate are preferable as the carboxylate ester. The carboxylate ester is effective in decreasing viscosity of the electrolytic solution as well as a chain carbonate. Therefore, for example, the carboxylate ester can be used instead of a chain carbonate or can be used together with a chain carbonate.

The chain carboxylate ester has an advantage of low viscosity when the number of carbon atoms of the substituent added to a “—COO—” structure is small, but the boiling point also tends to be lower). A chain carboxylate ester having a low boiling point may be evaporated during high temperature operation of the battery. On the other hand, when the number of carbon atoms is too large, viscosity of the electrolytic solution may become high, resulting in a decrease of electrical conductivity. For this reason, the total number of carbon atoms of two substituents added to a “—COO—” structure of the chain carbonate is preferably 3 or more and 8 or less. Moreover, when the substituent added to a “—COO—” structure contains a fluorine atom, oxidation resistance of the electrolytic solution can be improved. Thus, the chain carboxylate ester is preferably a fluorinated chain carboxylate ester represented by the following formula (7).

CₙH₂ₙ₊₁₋ₗFₗ—COO—CₘH₂ₘ₊₁₋ₖFₖ (7)

wherein n is 1, 2, 3 or 4; m is 1, 2, 3 or 4; 1 is any integer from 0 to 2n+1; k is any integer from 0 to 2m+1; and at least one of l and k is an integer of 1 or more.

In the fluorinated chain carboxylate ester shown by the formula (7), when the amount of fluorine substitution is low, the fluorinated chain carboxylate ester may react with the positive electrode of a high potential, and thereby a capacity retention ratio of the battery may fall or gas may be generated. On the other hand, if the amount of fluorine substitution is too high, compatibility of the chain carboxylate ester with the other solvents may fall, or a boiling point of the chain carboxylate ester may be decreased. For these reasons, the amount of fluorine substitution is preferably 1% or more and 90% or less, 10% or more and 85% or less is more preferable, and 20% or more and 80% or less is still more preferable. This means that, it is preferable that 1, m and n of the formula (7) satisfy the following formula.

0.01≦(l+k)/(2n+2m+2)≦0.9

The content of carboxylate ester in the nonaqueous electrolytic solvent is preferably 0.1 volume % or more, more preferably 0.2 volume % or more, still more preferably 0.5 volume % or more, and especially preferably 1 volume % or more. The content of the carboxylate ester in the nonaqueous electrolytic solvent is preferably 50 volume % or less, more preferably 20 volume % or less, still more preferably 15 volume % or less, and especially preferably 10 volume % or less. When the content of the carboxylate ester is 0.1 volume % or more, low temperature characteristics and electrical conductivity can be more improved. Meanwhile, when the content of the carboxylate ester is 50 volume % or less, it is possible to prevent the vapor pressure from becoming too high when the battery is left under high temperature.

The content of fluorinated chain carboxylate ester is not particularly limited, but 0.1 volume % or more and 50 volume % or less in the nonaqueous electrolytic solvent is preferable. When the content of the fluorinated chain carboxylate ester in the nonaqueous electrolytic solvent is 0.1 volume % or more, the viscosity of the electrolytic solution can be lowered to improve electrical conductivity. In addition, an effect of improving oxidation resistance is acquired. Meanwhile, when the content of the fluorinated chain carboxylate ester in the nonaqueous electrolytic solvent is 50 volume % or less, electrical conductivity of the electrolytic solution can be kept high and compatibility of the electrolytic solution can be ensured. The content of the fluorinated chain carboxylate ester in the nonaqueous electrolytic solvent is more preferably 1 volume % or more, still more preferably 5 volume % or more, and especially preferably 10 volume % or more. Additionally, the content of the fluorinated chain carboxylate ester in the nonaqueous electrolytic solvent is more preferably 45 volume % or less, still more preferably 40 volume % or less, and especially preferably 35 volume % or less.

In addition to the fluorine-containing phosphate ester, the nonaqueous electrolytic solvent can contain an alkylene biscarbonate represented by the following formula (8). Since oxidation resistance of an alkylene biscarbonate is equivalent to or slightly higher than that of chain carbonate, voltage endurance of the electrolytic solution can be improved.

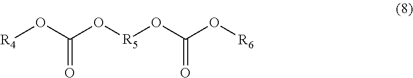

(R₄ and R₆ each independently denote substituted or unsubstituted alkyl group, and R₅ denotes substituted or unsubstituted alkylene group.)

In the formula (8), the alkyl group includes a straight chain alkyl or a branch chain alkyl. The number of carbon atoms thereof is preferably 1 to 6, and the number of carbon atoms of 1 to 4 is more preferable. The alkylene group is bivalent saturated hydrocarbon group and includes a straight chain alkylene or a branch chain alkylene. The number of carbon atoms thereof is preferably 1 to 4, and the number of carbon atoms of 1 to 3 is more preferable.

Examples of the alkylene biscarbonate represented by the formula (8) include 1,2-bis(methoxycarbonyloxy) ethane, 1,2-bis(ethoxycarbonyloxy) ethane, 1,2-bis(methoxycarbonyloxy) propane, and 1-ethoxycarbonyloxy-2-methoxycarbonyloxy ethane. Among these, 1,2-bis(methoxycarbonyloxy) ethane is preferable.

The content of the alkylene biscarbonate in the nonaqueous electrolytic solvent is preferably 0.1 volume % or more, more preferably 0.5 volume % or more, still more preferably 1 volume % or more, and especially preferably 1.5 volume % or more. The content of the alkylene biscarbonate in the nonaqueous electrolytic solvent is preferably 70 volume % or less, more preferably 60 volume % or less, still more preferably 50 volume % or less, and especially preferably 40 volume % or less.

The alkylene biscarbonate is a material having low permittivity. Therefore, for example, it can be used instead of a chain carbonate or together with a chain carbonate.

The nonaqueous electrolytic solvent may contain a chain ether in addition to the fluorine-containing phosphate ester.

The chain ether is not particularly limited, but includes, for example, 1,2-diethoxy ethane (DEE) and ethoxy methoxy ethane (EME). Moreover, the chain ether also contains a fluorinated chain ether. The fluorinated chain ether has high oxidation resistance, and is preferably used in the case of the positive electrode operating at a high potential. Examples of the fluorinated chain ether include a compound having a structure in which some or all of hydrogen atoms in 1,2-diethoxy ethane (DEE) or ethoxy methoxy ethane (EME) are replaced with fluorine atoms. Moreover, specific examples of a fluorine-containing chain ether include 2,2,3,3,3-pentafluoropropyl 1,1,2,2-tetrafluoroethyl ether, 1,1,2,2-tetrafluoroethyl 2,2,2-trifluoroethyl ether, 1H,1H,2′H,3H-decafluorodipropyl ether, 1,1,1,2,3,3-hexafluoropropyl-2,2-difluoroethyl ether, isopropyl 1,1,2,2-tetrafluoroethyl ether, propyl 1,1,2,2-tetrafluoroethyl ether, 1,1,2,2-tetrafluoroethyl 2,2,3,3-tetrafluoropropyl ether, 1H,1H,5H-perfluoropentyl-1,1,2,2-tetrafluoroethyl ether, 1H,1H,2′H-perfluorodipropyl ether, 1H-perfluorobutyl-1H-perfluoroethyl ether, methyl perfluoropentyl ether, methyl perfluorohexyl ether, methyl 1,1,3,3,3-pentafluoro-2-(trifluoromethyl)propyl ether, 1,1,2,3,3,3-hexafluoropropyl 2,2,2-trifluoroethyl ether, ethyl nonafluorobutyl ether, ethyl 1,1,2,3,3,3-hexafluoropropyl ether, 1H,1H,5H-octafluoropentyl 1,1,2,2-tetrafluoroethyl ether, 1H,1H,2′H-perfluorodipropyl ether, heptafluoropropyl 1,2,2,2-tetrafluoroethyl ether, 1,1,2,2-tetrafluoroethyl-2,2,3,3-tetrafluoropropyl ether, 2,2,3,3,3-pentafluoropropyl-1,1,2,2-tetrafluoroethyl ether, ethyl nonafluorobutyl ether, methyl nonafluorobutyl ether and the like. Among these, from the viewpoints of voltage endurance, a boiling point and the like, 1,1,2,2-tetrafluoroethyl-2,2,3,3-tetrafluorpropyl ether, 1H,1H,2′H,3H-decafluorodipropyl ether, 1H,1H,2′H-perfluorodipropyl ether, ethyl nonafluorobutyl ether and the like are preferable. A chain ether is, as a chain carbonate, effective in reducing viscosity of an electrolytic solution. Therefore, for example, a chain ether can be used instead of a chain carbonate or a carboxylate ester, and can be used together with a chain carbonate and a carboxylate ester.

The chain ether may be evaporated at the time of high temperature operation of the battery because its boiling point tends to become low when the number of carbon atoms is small. On the other hand, when the number of carbon atoms is too large, viscosity of the chain ether may become high, resulting in decrease in electrical conductivity of the electrolytic solution. Therefore, the number of carbon atoms is preferably 4 or more and 10 or less. For this reason, the chain ether is preferably a fluorinated chain ether represented by the following formula (9).

CₙH₂ₙ₊₁₋ₗFₗ—O—CₘH₂ₘ₊₁₋ₖFₖ (9)

wherein n is 1, 2, 3, 4, 5 or 6; m is 1, 2, 3 or 4; 1 is any integer from 0 to 2n+1; k is any integer from 0 to 2m+1; and at least one of l and k is an integer of 1 or more.

In the fluorinated chain ether shown by the formula (9), when the amount of fluorine substitution is too low, the fluorinated chain ether may react with the positive electrode of a high potential, and thereby a capacity retention ratio of the battery may fall or gas may be generated. On the other hand, when the amount of fluorine substitution is too high, compatibility of the fluorinated chain ether with the other solvents may decrease, or a boiling point of the fluorinated chain ether may be lowered. For these reasons, the amount of fluorine substitution is preferably 10% or more and 90% or less, more preferably 20% or more and 85% or less, and still more preferably 30% or more and 80% or less. This means that, it is preferable that 1, m and n of the formula (9) satisfy the following formula.

0.1≦(l+k)/(2n+2m+2)≦0.9

The content of the fluorinated chain ether is not particularly limited, but 0.1 volume % or more and 70 volume % or less in a nonaqueous electrolytic solvent is preferable. When the content of the fluorinated chain ether in the nonaqueous electrolytic solvent is 0.1 volume % or more, viscosity of the electrolytic solution can be lowered to improve electrical conductivity. In addition, an effect of improving oxidation resistance is acquired. Meanwhile, when the content of the fluorinated chain ether in the nonaqueous electrolytic solvent is 70 volume % or less, it is possible to keep high electrical conductivity of the electrolytic solution and to ensure compatibility of the electrolytic solution. Moreover, the content of the fluorinated chain ether in the nonaqueous electrolytic solvent is more preferably 1 volume % or more, still more preferably 5 volume % or more, and especially preferably 10 volume % or more. The content of the fluorinated chain ether in the nonaqueous electrolytic solvent is more preferably 65 volume % or less, still more preferably 60 volume % or less, and especially preferably 55 volume % or less.

The nonaqueous electrolytic solvent may contain the following compounds in addition to the above ones. The nonaqueous electrolytic solvent can contain, for example, γ-lactones such as γ-butyrolactone, chain ethers such as 1,2-ethoxyethane (DEE) and ethoxy methoxy ethane (EME), and cyclic ethers such as tetrahydrofuran and 2-methyl tetrahydrofuran. Furthermore, the nonaqueous electrolytic solvent may also contain a compound in which a part of hydrogen atoms of the above materials are replaced with fluorine atoms. In addition, the nonaqueous electrolytic solvent may also contain an aprotic organic solvent such as dimethyl sulfoxide, 1,3-dioxolane, formamide, acetamide, dimethylformamide, dioxolane, acetonitrile, propylnitrile, nitromethane, ethyl monoglyme, trimethoxymethane, dioxolane derivatives, sulfolane, methylsulfolane, 1,3-dimethyl-2-imidazolidinone, 3-methyl-2-oxazolidinone, propylene carbonate derivatives, tetrahydrofuran derivatives, ethyl ether, 1,3-propane sultone, anisole, and N-methylpyrrolidone.

Examples of a supporting salt include lithium salts such as LiPF₆, LiAsF₆, LiAlCl₄, LiClO₄, LiBF₄, LiSbF₆, LiCF₃SO₃, LiC₄F₉CO₃, LiC(CF₃SO₂)₂, LiN(CF₃SO₂)₂, LiN(C₂F₅SO₂)₂, LiB₁₀Cl₁₀. Furthermore, another supporting salt includes lower aliphatic lithium carboxylate, chloroboran lithium, lithium tetraphenylborate, LiBr, LiI, LiSCN and LiCl and the like. The supporting salt can be used singly or in combinations of two or more.

Moreover, an ion conductive polymer can be added to a nonaqueous electrolytic solvent. Examples of the ion conductive polymer include polyether such as polyethylene oxide and polypropylene oxide, and polyolefin such as polyethylene and polypropylene. Examples of the ion conductive polymer include polyvinylidene fluoride, polytetrafluoroethylene, polyvinyl fluoride, polyvinyl chloride, polyvinylidene chloride, polymethylmethacrylate, polymethylacrylate, polyvinyl alcohol, polymethacrylonitrile, polyvinylacetate, polyvinylpyrrolidinone, polycarbonate, polyethylene terephthalate, polyhexamethylene adipamide, polycaprolactam, polyurethane, polyethylene imine, polybutadiene, polystyrene, polyisoprene, and derivatives thereof. The ion conductive polymer can be used singly or in combinations of two or more. A polymer containing various monomers that constitute the above-mentioned polymer may be also used.

### (Positive Electrode)

The positive electrode contains a positive electrode active material, and the positive electrode active material operates at a potential of 4.5 V or more versus lithium. The positive electrode is prepared by, for example, binding the positive electrode active material with a binder for positive electrode so as to cover a current collector for the positive electrode.

In addition, the positive electrode active material operating at a potential of 4.5 V or more versus lithium can be selected by the following methods, for example. First, Li metal and a positive electrode containing a positive electrode active material are opposed to each other with a separator sandwiched therebetween and placed in a battery. Then, an electrolytic solution is injected to produce the battery. When charge and discharge are performed at a constant current of, for example, 5 mAh/g per mass of the positive electrode active material of the positive electrode, the positive electrode active material having a charge-discharge capacity of 10 mAh/g or more per mass of the active material at a potential of 4.5 V or more versus lithium can be defined as the positive electrode active material operating at a potential of 4.5 V or more versus lithium. Moreover, when charge and discharge are performed at a constant current of 5 mAh/g per mass of the positive electrode active material of the positive electrode, the positive electrode active material preferably has a charge-discharge capacity of 20 mAh/g or more per mass of the active material at a potential of 4.5 V or more versus lithium, 50 mAh/g or more is more preferable, and 100 mAh/g or more is still more preferable. As for the form of the battery, a coin type can be used, for example.

It is preferable that the positive electrode active material contain an active material operating at a potential of 4.5 V or more versus lithium and contain a lithium manganese composite oxide represented by the following formula (10). The lithium manganese composite oxide represented by the following formula (10) is an active material that operates at a potential of 4.5 V or more versus lithium.

Liₐ(MₓMn_{2-x-y}Y_{y})(O_{4-w}Z_{w}) (10)

wherein 0.5≦x≦1.2, 0≦y, x+y<2, 0≦a≦1.2, and 0≦w≦1; M is at least one selected from the group consisting of Co, Ni, Fe, Cr and Cu; Y is at least one selected from the group consisting of Li, B, Na, Al, Mg, Ti, Si, K and Ca; and Z is at least one selected from the group consisting of F and Cl.

In the formula (10), M preferably includes Ni, and more preferably M is only Ni. This is because when M includes Ni, a high capacity active material is relatively easily obtained. When M consists of only Ni, x is preferably 0.4 or more and 0.6 or less from a viewpoint of obtaining a high capacity active material. Moreover, it is more preferable that the positive electrode active material is LiNi_{0.5}Mn_{0.5}O₄ since high capacity of 130 mAh/g or more is obtained.

Moreover, examples of the active material which operates at a potential of 4.5 V or more versus lithium include LiCrMnO₄, LiFeMnO₄, LiCoMnO₄, and LiCu_{0.5}Mn_{0.5}O₄. These positive electrode active materials have high capacity. In addition, the positive electrode active material may also have a mixed composition of these active materials and LiNi_{0.5}Mn_{0.5}O₄.

Furthermore, in some cases, a life can be improved by replacing a part of Mn of these active materials with Li, B, Na, Al, Mg, Ti, Si, K, Ca or the like. In short, when 0<y in a formula (10), a life may be improved. Among these, when Y is Al, Mg, Ti or Si, the effect of life improvement is high. Moreover, Y is more preferably Ti because the life improvement effect is exhibited while maintaining high capacity. The range of y is preferably more than zero and 0.3 or less. When y is 0.3 or less, it becomes easy to suppress a decrease in capacity.

Furthermore, it is possible to replace an oxygen moiety with F or Cl. In the formula (10), when w is set to more than 0 and 1 or less, a decrease in capacity can be suppressed.

Moreover, the active material operating at a potential of 4.5 V or more versus lithium includes a spinel type and olivine type materials. Examples of the spinel type positive electrode active material include LiNi_{0.5}Mn_{4.5}O₄, LiCrₓMn₂₋ₓO₄ (0.4≦x≦1.1), LiFeₓMn₂₋ₓO₄ (0.4≦x≦1.1), LiCuₓMn₂₋ₓO₄ (0.3≦x≦0.6), LiCoₓMn₂₋ₓO₄ (0.4≦x≦1.1) and solid solutions thereof. In addition, the olivine type positive electrode active material includes;

LiMPO₄ (11)

wherein M is at least one of Co and Ni. For example, LiCoPO₄, LiNiPO₄ and the like are exemplified.

Moreover, the active material operating at a potential of 4.5 V or more versus lithium also includes a Si composite oxide. Examples of the Si composite oxide include Li₂MSiO₄ (M: at least one of Mn, Fe and Co).

Besides, the active material operating at a potential of 4.5 V or more versus lithium also includes a material including a layer structure. Examples of the positive electrode active material including a layer structure include Li(M1ₓM_{2y}Mn_{2-x-y})O₂ (M1; at least one selected from the group consisting of Ni, Co and Fe; M2: at least one selected from the group consisting of Li, Mg and Al; 0.1<x<0.5, 0.05<y<0.3).

Moreover, the compounds represented by the following formula (12) or the following formula (13) are also exemplified as the positive electrode active material having a layer structure.

Li(M_{1-z}Mn_{z})O₂ (12)

wherein 0.7≧z≧0.33, and M is at least one of Li, Co and Ni.

Li(LiₓM_{1-x-z}Mn_{z})O₂ (13)

wherein 0.3>x≧0.1, 0.7≧z≧0.33, and M is at least one of Co and Ni.

The specific surface area of the lithium manganese composite oxide represented by the above formula (10) is, for example, 0.01 to 5 m²/g, preferably 0.05 to 4 m²/g, more preferably 0.1 to 3 m²/g, and still more preferably 0.2 to 2 m²/g. When the specific surface area is set within such a range, a contact area with an electrolytic solution can be adjusted to a suitable range. That is, when the specific surface area is set to 0.01 m²/g or more, it becomes easy to perform intercalation and deintercalation of a lithium ion smoothly and therefore resistance can be more reduced. Moreover, when the specific surface area is set to 5 m²/g or less, it is possible to more suppress progress of decomposition of an electrolytic solution and elution of a component element of the active material.

A median particle size of the above-mentioned lithium manganese composite oxide is preferably 0.1 to 50 μm and more preferably 0.2 to 40 μm. When the particle size is 0.1 μm or more, it is possible to more suppress elution of a component element such as Mn and degradation by contact with an electrolytic solution. Moreover, when the particle size is 50 μm or less, it becomes easy to perform intercalation and deintercalation of a lithium ion smoothly and therefore resistance can be more reduced. Measurement of a particle size can be carried out with a laser diffraction/dispersion type particle size distribution measuring apparatus.

As mentioned above, the positive electrode active material contains the active material operating at a potential of 4.5 V or more versus lithium, and may also contain a 4 V class active material.

As for a binder for positive electrode, the same agent as the binder for negative electrode can be used. Among these, from the viewpoint of versatility and low cost, polyvinylidene fluoride is preferable. In view of trade-off relationship between “sufficient adhesive power” and “high energy”, the amount of the binder to be used for positive electrode is preferably 2 to 10 mass parts with respect to 100 mass parts of the positive electrode active material.

A positive electrode current collector is not particularly limited, but includes, for example, polyvinylidene fluoride (PVdF), vinylidene fluoride-hexafluoropropylene copolymer, vinylidene fluoride-tetrafluoroethylene copolymer, styrene-butadiene copolymer rubber, polytetrafluoroethylene, polypropylene, polyethylene, polyimide, and polyamideimide.

A conductive assistant may be added to a positive electrode active material layer containing a positive electrode active material in order to reduce impedance. The conductive assistant includes a carbonaceous microparticle such as graphite, carbon black, and acetylene black.

### (Negative Electrode)

The negative electrode is not particularly limited as long as a material capable of intercalating and deintercalating lithium is contained therein as a negative electrode active material.

The negative electrode active material is not particularly limited, but it includes, for example, a carbon material capable of intercalating and deintercalating a lithium ion (a), a metal capable of forming an alloy with lithium (b), and a metal oxide capable of intercalating and deintercalating a lithium ion (c).

As a carbon material (a), graphite, amorphous carbon, diamond-like carbon, a carbon nanotube, or a composite thereof can be used. High crystalline graphite has high electrical conductivity and excels in voltage flatness and adhesiveness with a positive electrode current collector composed of a metal such as copper. On the other hand, low crystalline amorphous carbon has a relatively lower volume expansion and therefore has large effect to relax volume expansion of the whole negative electrode. Further, degradation resulting from non-uniformity such as a crystal particle boundary and a defect rarely occurs. The carbon material (a) can be used singly or together with another active material. The content is preferably in the range of 2 mass % or more and 80 mass % or less in the negative electrode active material, and more preferably, in the range of 2 mass % or more and 30 mass % or less.

As the metal (b), metals mainly composed of Al, Si, Pb, Sn, Zn, Cd, Sb, In, Bi, Ag, Ba, Ca, Hg, Pd, Pt, Te, or La; or an alloy containing two or more of the above metals; or an alloy of lithium with the above metals or alloys and the like can be used. In particular, it is preferred to contain silicon (Si) as the metal (b). The metal (b) can be used singly or together with another active material. The content is preferably in the range of 5 mass % or more and 90 mass % or less in the negative electrode active material, and more preferably, in the range of 20 mass % or more and 50 mass % or less.

As the metal oxide (c), silicon oxide, aluminum oxide, tin oxide, indium oxide, zinc oxide, lithium oxide, or a composite containing two or more of these oxides can be used. Especially, it is preferable to contain silicon oxide as the metal oxide (c). This is because silicon oxide is relatively stable and is hard to trigger a reaction with other compounds. Moreover, one or more of elements selected from nitrogen, boron and sulfur may also be added to the metal oxide (c) in an amount of, for example, 0.1 to 5 mass %. Thereby, electrical conductivity of the metal oxide (c) can be raised. Whereas the metal oxide (c) can be used singly or together with another active material, the content in the negative electrode active material is preferably in the range of 5 mass % or more and 90 mass % or less, and more preferably in the range of 40 mass % or more and 70 mass % or less.

Specific examples of the metal oxide (c) include, for example, LiFe₂O₃, WO₂, MoO₂, SiO, SiO₂, CUO, SnO, SnO₂, Nb₃O₅, LiₓTi₂₋ₓO₄ (1≦x≦4/3), PbO₂ and Pb₂O₅.

Examples of another negative electrode active material include a metal sulfide (d) capable of intercalating and deintercalating a lithium ion. Examples of the metal sulfide (d) include SnS and FeS₂. In addition, examples of the negative electrode active material further include lithium metal, lithium alloy, polyacene, polythiophene, and lithium nitrides such as Li₅(Li₃N), Li₇MnN₄, Li₃FeN₂, Li_{2.5}Co_{0.5}N and Li₃CoN.

The above negative electrode active materials can be used singly or in combinations of two or more.

Moreover, the negative electrode active material may contain a carbon material (a), a metal (b) and a metal oxide (c). Hereafter, this negative electrode active material will be described.

It is preferable that a part or the whole of the metal oxide (c) have an amorphous structure. The metal oxide (c) having an amorphous structure can suppress volume expansion of the carbon material (a) and the metal (b), and can also suppress decomposition of the electrolytic solution. As a mechanism of this, it is assumed that the amorphous structure of the metal oxide (c) exerts a certain influence on film formation at the interface between the carbon material (a) and the electrolytic solution. In addition, it is considered that in the amorphous structure, factors resulting from heterogeneity such as a crystal particle boundary and a defect are relatively small. Whether a part or the whole of the metal oxide (c) has an amorphous structure can be confirmed by X-ray diffraction measurement (general XRD measurement). Specifically, when the metal oxide (c) does not have an amorphous structure, a peak intrinsic to the metal oxide (c) is observed, whereas when a part or the whole of the metal oxide (c) has an amorphous structure, the intrinsic to the metal oxide (c) is observed as a broad peak.

The metal oxide (c) is preferably an oxide of a metal which constitutes the metal (b). Moreover, it is preferable that the metal (b) and metal oxide (c) be silicon (Si) and silicon oxide (SiO), respectively.

The whole or a part of the metal (b) is preferably distributed in the metal oxide (c). When at least a part of the metal (b) is distributed in the metal oxide (c), volume expansion of the whole negative electrode can be more suppressed, and decomposition of an electrolytic solution can be also suppressed. The distribution of the whole or a part of the metal (b) in the metal oxide (c) can be observed by using a combination of transmission electron microscope observation (general TEM observation) and energy dispersion type X-ray spectroscopy measurement (general EDX measurement). Specifically, a section of a sample containing metal (b) particles is observed, and oxygen concentration of the metal (b) particles distributed in the metal oxide (c) is measured, and thereby it can be confirmed that the metal constituting the metal (b) particles does not become an oxide.

As described above, each content of the carbon material (a), metal (b) and metal oxide (c) with respect to the total of the carbon material (a), metal (b) and metal oxide (c) is preferably set to 2 mass % or more and 80 mass % or less, 5 mass % or more and 90 mass % or less, and 5 mass % or more and 90 mass % or less, respectively. In addition, each content of the carbon material (a), metal (b) and metal oxide (c) with respect to the total of the carbon material (a), metal (b) and metal oxide (c) is more preferably set to 2 mass % or more and 30 mass % or less, 20 mass % or more and 50 mass % or less, and 40 mass % or more and 70 mass % or less, respectively.

The negative electrode active material, in which the whole or a part of the metal oxide (c) has an amorphous structure and the metal (b) is wholly or partially distributed in the metal oxide (c), can be produced by, for example, the method disclosed in the Japanese Patent Laid-Open No. 2004-47404. Specifically, the metal oxide (c) is subjected to CVD processing under the atmosphere containing organic compound gas such as methane gas, so that a composite in which the metal (b) in the metal oxide (c) turns to a nanocluster and whose surface is covered with the carbon material (a) can be obtained. In addition, the above-mentioned negative electrode active material can be also produced by mixing the carbon material (a), metal (b) and metal oxide (c) with a mechanical milling.

The carbon material (a), metal (b) and metal oxide (c) are not particularly limited, but a particle-shaped one can be used, respectively. For example, an average particle size of the metal (b) may be set to be smaller than that of the carbon material (a) and that of the metal oxide (c). In this case, the metal (b) having a large volume change during charge and discharge forms a relatively small particle, and the carbon material (a) and metal oxide (c) having a small volume change forms a relatively large particle, and therefore dendrite generation and micropowderization of the alloy are suppressed more effectively. Moreover, in process of charge and discharge, intercalation and deintercalation of lithium is performed by turns in order of particles with large diameter, particles with small diameter, and particles with large diameter. Also from this point, remaining stress and remaining distortion are suppressed. The average particle size of the metal (b) can be, for example, 20 μm or less, and preferably 15 μm or less.

Moreover, an average particle size of the metal oxide (c) is preferably ½ or less of that of the carbon material (a), and an average particle size of the metal (b) is preferably ½ or less of that of the metal oxide (c). Furthermore, it is more preferable that an average particle size of the metal oxide (c) be ½ or less of that of the carbon material (a) and further that the average particle size of the metal (b) be ½ or less of that of the metal oxide (c). When an average particle size is controlled in such a range, relaxation effect on volume expansion of the metal and alloy phase can be obtained more effectively, and thus it is possible to obtain a secondary battery having excellent energy density and excellent balance of cycle life and efficiency. More specifically, it is preferable that an average particle size of the silicon oxide (c) be ½ or less of that of graphite (a) and that an average particle size of silicon (b) be ½ or less of that a silicon oxide (c). Still more specifically, the average particle size of silicon (b) can be, for example, 20 μm or less and preferably 15 μm or less.

Graphite whose surface is covered with a low crystalline carbon material can be used as a negative electrode active material. By covering the graphite surface with a low crystalline carbon material, even when graphite having high energy density and high electrical conductivity is used as a negative electrode active material, reaction of the negative electrode active material and the electrolytic solution can be suppressed. Therefore, by using graphite covered with a low crystalline carbon material as a negative electrode active material, a capacity retention ratio can be improved and a capacity of the battery can be also improved.

In the low crystalline carbon material that covers a graphite surface, a ratio I_{D}/I_{G} is preferably 0.08 or more and 0.5 or less, in which the I_{D}/I_{G} represents a ratio of a peak intensity I_{D} of D peak generated in the range of 1300 cm⁻¹ to 1400 cm⁻¹ in Raman spectrum obtained by laser Raman analysis with respect to a peak intensity I_{G} of G peak generated in the range of 1550 cm⁻¹ to 1650 cm⁻¹. Generally, a carbon material with high crystallinity shows a low I_{D}/I_{G} value, and carbon with low crystallinity shows a high I_{D}/I_{G} value. When I_{D}/I_{G} is 0.08 or more, even in the case of operation at a high voltage, reaction of graphite with the electrolytic solution can be suppressed, and the capacity retention ratio of the battery can be improved. When I_{D}/I_{G} is 0.5 or less, the battery capacity can be increased. Moreover, I_{D}/I_{G}, is more preferably 0.1 or more and 0.4 or less.

For the laser Raman analysis of the low crystalline carbon material, for example, an argon-ion laser Raman analysis apparatus can be used. In the case of a material with large laser absorption such as a carbon material, a laser is absorbed within up to several 10 nm from the surface. Therefore, the laser Raman analysis on the graphite whose surface is covered with the low crystalline carbon material substantially provides information of the low crystalline carbon material deposited on the surface.

I_{D} value or I_{G} value can be calculated from, for example, laser Raman spectrum measured by the following condition.

Laser Raman spectrum equipment: Ramanor T-64000 (Jobin Yvon/manufactured by Atago Bussan Co., Ltd.)
Measurement mode: Macroraman
Measurement arrangement: 60°
Diameter of beam: 100 μm
Light source: Ar+ laser/514.5 nm
Leather power: 10 mW
Diffraction grating: Single 600 gr/mm

### Distribution: Single 21 A/mm

### Slit: 100 μm

### Detector: CCD/Jobin Yvon 1024256

The graphite covered with a low crystalline carbon material can be obtained, for example, by covering a particulate graphite with the low crystalline carbon material. The average particle size (volume average: D₅₀) of the graphite particles is preferably 5 μm or more and 30 μm or less. The graphite preferably has crystallinity, and the I_{D}/I_{G} value of the graphite is more preferably 0.01 or more and 0.08 or less.

The thickness of the low crystalline carbon material is preferably 0.01 μm or more and 5 μm or less, and more preferably 0.02 μm or more and 1 μm or less.

The average particle size (D₅₀) can be measured using, for example, a laser diffraction/dispersion type particle diameter/size distribution measuring apparatus Microtrac MT3300EX (Nikkiso Co., Ltd.).

The low crystalline carbon material can be formed on the surface of graphite by using, for example, a gaseous phase method in which hydrocarbon such as propane and acetylene is thermally decomposed to deposit carbon. Also, the low crystalline carbon material can be formed by using, for example, a method in which pitch, tar or the like is adhered onto the surface of graphite and calcined at 800 to 1500° C.

As for graphite, the layer distance of (002) plane d₀₀₂ is preferably 0.33 nm or more and 0.34 nm or less in a crystal structure, and is more preferably 0.333 nm or more and 0.337 nm or less, and is still more preferably, 0.336 nm or less. Graphite with such a high crystallinity has high lithium intercalation capacity, and an improvement in charge-discharge efficiency can be expected.

The layer distance of graphite can be measured by, for example, X-ray diffraction.

The specific surface area of the graphite covered with the low crystalline carbon material is, for example, 0.01 to 20 m²/g, preferably 0.05 to 10 m²/g, more preferably 0.1 to 5 m²/g, and still more preferably 0.2 to 3 m²/g. When the specific surface area of the graphite covered with the low crystalline carbon material is set to 0.01 m²/g or more, intercalation and deintercalation of a lithium ion tends to be performed smoothly, and thus the resistance can be more decreased. When the specific surface area of the graphite covered with the low crystalline carbon material is set to 20 m²/g or less, decomposition of the electrolytic solution can be more suppressed, and elution of component elements of the active material to the electrolytic solution can be more suppressed.

The graphite used as substrate material is preferably a high crystallinity one. For example, synthetic graphite and natural graphite can be used, but it is not limited to them. As for a material of the low crystalline carbon, for example, coal tar, a pitch coke and phenol based resin may be used, in a mixture with high crystalline carbon. The material of the low crystalline carbon is mixed in 5 to 50 mass % with respect to the high crystalline carbon to prepare the mixture. After the mixture is heated at 150° C. to 300° C., heat treatment is further performed at 600° C. to 1500° C. Thereby, a surface-treated graphite whose surface is covered with the low crystalline carbon can be obtained. It is preferable to carry out the heat treatment in an inert gas atmosphere such as argon, helium and nitrogen. The negative electrode active material may contain another active material in addition to the graphite covered with the low crystalline carbon material.

A binder for the negative electrode is not particularly limited, but includes polyvinylidene fluoride (PVdF), vinylidene fluoride-hexafluoropropylene copolymer, vinylidene fluoride-tetrafluoroethylene copolymer, styrene-butadiene copolymer rubber, polytetrafluoroethylene, polypropylene, polyethylene, polyimide, and polyamideimide.

It is preferable that the content of the negative electrode binder be in the range of 1 to 30 mass % based on the total amount of the negative electrode active material and the negative electrode binder, and 2 to 25 mass % is more preferable. With 1 mass % or more, adhesion between the active materials or between the active material and a current collector is improved and therefore cycle characteristic becomes excellent. Moreover, with 30 mass % or less, a content ratio of the active material is increased to allow for an improvement in negative electrode capacity.

A negative electrode current collector is not particularly limited. In view of electrochemical stability, aluminum, nickel, copper, silver, and an alloy thereof are preferable. Its shape includes foil, plate-like and mesh-like.

The negative electrode can be produced by forming a negative electrode active material layer on a negative electrode current collector, wherein the negative electrode active material layer contains a negative electrode active material and a binder. The forming method of the negative electrode active material layer includes a doctor blade method, a die coater method, a CVD method and a sputtering method and the like. After forming the negative electrode active material layer in advance, a thin film of aluminum, nickel or an alloy thereof may be formed as a negative electrode current collector by a method such as vapor deposition and sputtering.

### (Separator)

The secondary battery can be constituted by a combination of a positive electrode, a negative electrode, a separator and a nonaqueous electrolyte. Examples of a separator include: a woven or nonwoven fabric; a porosity polymer film such as polyolefin (such as polyethylene and polypropylene), polyimide, porosity polyvinylidene fluoride film; and an ion conductive polymer electrolyte film. These can be used alone or in combination.

### (The Shape of the Battery)

Examples of the shape of the battery include a cylinder type, a square type, a coin type, a button type and a laminated type. Examples of an outer package of the battery include stainless steel, iron, aluminum, titanium and an alloy thereof or a plating-processed product thereof and the like. Examples of the plating include nickel plating.

Examples of a laminate resin film used for a laminate type include aluminium, an aluminium alloy and a titanium foil. Examples of a material of heat meltadhesion part of the metal laminated resin film include thermoplastic polymer materials such as polyethylene, polypropylene and polyethylene terephthalate. Moreover, the metal laminate resin layer and the metallic foil layer are respectively not limited to a single layer, and two or more layers may be formed.

An outer package can be appropriately selected as long as it has stability in an electrolytic solution and sufficient steam barrier properties. For example, in the case of a laminate type secondary battery, laminate films, such as polypropylene, polyethylene or the like coated with aluminium or silica can be used as the outer package. In particular, it is preferable to use an aluminium laminate film from a viewpoint of suppressing volume expansion.

### EXAMPLES

### Example 1

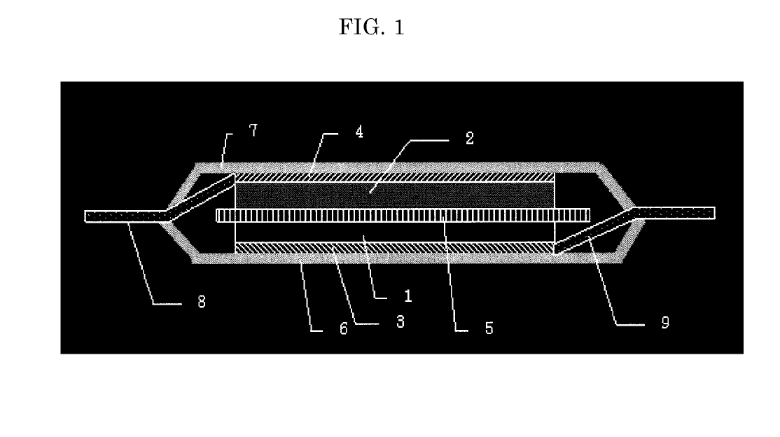

Hereafter, there will be described specific examples to which the present invention is applied, but the scope of the present invention is not limited to these Examples, and the present invention can be embodied with appropriate modification within the scope of the present invention. FIG. 1 is a schematic diagram showing the structure of the lithium secondary battery produced in this Example.

As shown in FIG. 1, a lithium secondary battery has: a positive electrode active material layer 1 containing a positive electrode active material on a positive electrode current collector 3 made of metal such as aluminium foil; and a negative electrode active material layer 2 containing a negative electrode active material on a negative electrode current collector 4 made of metal such as copper foil. The positive electrode active-material layer 1 and negative electrode active-material layer 2 are arranged so as to face each other interposing an electrolytic solution and a separator 5 made of nonwoven fabric, polypropylene microporous film and the like which contains the electrolytic solution. In FIGS. 1, 6 and 7 show an outer package, 8 shows a negative electrode tab, and 9 shows a positive electrode tab.

The positive electrode active material of the present Example was produced in the following manner. As raw materials, materials selected from MnO₂, NiO, Fe₂O₃, TiO₂, B₂O₃, CoO, Li₂CO₃, MgO, Al₂O₃ and LiF were weighed so as to be a desired metal composition ratio, and then grinded and mixed. The powder after mixing the raw materials was calcined for 8 hours at a calcination temperature of 500 to 1000° C. to prepare LiNi_{0.5}Mn_{0.5}O₄. LiNi_{0.5}Mn_{1.5}O₄ as a positive electrode active material, polyvinylidene fluoride (PVDF) (5 mass %) as a binder, and carbon black (5 mass %) as an electric conductive agent were mixed to obtain a positive electrode mixture. The positive electrode mixture is dispersed in N-methyl-2-pyrrolidone to prepare slurry for positive electrode. This slurry for positive electrode was uniformly applied to one side of a 20 μm thick current collector made of aluminum. The thickness of the applied film was adjusted so that the initial charge capacity per unit area was set to 2.5 mAh/cm². After drying the resultant, compression molding was carried out by a roll press to produce a positive electrode.

For a negative electrode active material, artificial graphite was used. The artificial graphite was dispersed in a solution in which PVDF was dissolved into N-methylpyrrolidone to prepare slurry for negative electrode. The mass ratio of the negative electrode active material and the binder was set to 90/10. This slurry for negative electrode was uniformly applied on a 10 μm thick Cu current collector. After drying, compression molding was carried out by a roll press to produce a negative electrode.

The positive electrode and negative electrode which were cut to 1.5 cm×3 cm were arranged via a separator so as to be faced with each other. Five sheets of the positive electrode and six sheets of the negative electrode were stacked alternately. A fine porosity polypropylene film with 25 μm thickness was used for a separator.

As for a nonaqueous electrolytic solvent, there were used a solvent in which ethylene carbonate (EC), dimethyl carbonate (DMC), tris(2,2,2-trifluoroethyl)phosphate (PTTFE) and a fluorinated chain ether (1,1,2,2-tetrafluoroethyl-2,2,3,3-tetrafluoropropyl ether) (TFETFPE) were mixed. Hereafter, this solvent is also abbreviated to solvent EC/DMC/PTTFE/TFETFPE. The volume ratio of PTTFE was set to 40% (volume ratio: EC/DMC/PTTFE/TFETFPE=3/1/4/2). LiPF₆ was dissolved in a concentration of 1 mol/l into this nonaqueous electrolytic solvent to prepare an electrolytic solution. To this, 0.67 wt % of cyclic disulfonate ester (1,5,2,4-dioxadithiane-2,2,4,4-tetraoxide) represented by the following formula (11) was added as an additive.

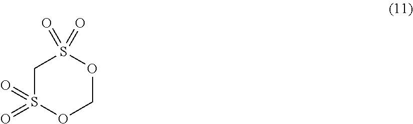

The above-mentioned positive electrode, negative electrode, separator and electrolytic solution were placed in a laminate outer package, and the laminate was sealed to produce a lithium secondary battery. Tabs were connected to the positive electrode and negative electrode that were electrically connected from the outside of the laminate.

First, charge and discharge were performed under the following charge condition.

Charge condition: a constant current constant voltage method, charge end voltage 4.75 V, charge current 10 mA, the total charge time 2.5 hours

Discharge condition: constant current discharge, discharge end voltage 3.0 V, discharge current 50 mA

Next, the temperature was set to 20° C. or 45° C., and charge-discharge cycle examination was carried out under the following condition.

Charge condition: a constant current constant voltage type, charge end voltage 4.75 V, charge current 50 mA, the total charge time 2.5 hours

Discharge condition: constant current discharge, discharge end voltage 3.0 V, discharge current 50 mA

The capacity retention ratio after 20° C. 500 cycles was 84%, and the amount of gas generation in 45° C. 200 cycles was 0.3 cc. The weight of the cell was measured in water and in the atmosphere, the volume was determined by the Archimedes method, and the amount of gas generation was calculated from volume change before and after evaluation. The capacity retention ratio (%) is a ratio of a discharge capacity (mAh) after 500 cycles to a discharge capacity (mAh) at the first cycle.

### Comparative Example 1

A secondary battery was produced in the same manner as in Example 1 except that a mixed solvent of EC/DMC/TFETFPE (volume ratio: EC/DMC/TFETFPE=4/2/4) was used as a nonaqueous electrolytic solvent, and that no additive (cyclic sulfonate ester) was added. The capacity retention ratio after 20° C. 500 cycles was 70%, the capacity retention ratio after 45° C. 300 cycles was 55%, and the amount of gas generation in 45° C. 200 cycles was 0.7 cc.

### Comparative Example 2

The cyclic disulfonate ester represented by the above-mentioned formula (11) was added in an amount of 1.5 wt % to the above-mentioned EC/DMC/TFETFPE solvent (volume ratio: EC/DMC/TFETFPE=4/2/4) as a nonaqueous electrolytic solvent. A secondary battery was produced in the same manner as in Example 1 except for using this solvent. The capacity retention ratio after 45° C. 300 cycles was 45%, and the amount of gas generation in 45° C. 200 cycles was 2.2 cc.

### Comparative Example 3

A secondary battery was produced in the same manner as in Example 1 except for using EC/DMC/PTTFE/TFETFPE (volume ratio: EC/DMC/PTTFE/TFETFPE=3/1/4/2) as a nonaqueous electrolytic solvent and for adding no additive (cyclic sulfonate ester). The capacity retention ratio after 20° C. 500 cycles was 20%, and the amount of gas generation in 45° C. 300 cycles was 0.3 cc.

In the above-mentioned Example 1 and Comparative Examples 1 to 3, there was used a positive electrode active material that operates at a potential of 4.5 V or more versus lithium. In Example 1, there was used an electrolytic solution containing 1,5,2,4-dioxadithiane-2,2,4,4-tetraoxide as a cyclic sulfonate ester and PTTFE as a fluorine-containing phosphate ester. In Comparative Example 1, an electrolytic solution containing neither a cyclic sulfonate ester nor a fluorine-containing phosphate ester was used. In Comparative Example 2, there was used an electrolytic solution that contains a cyclic sulfonate ester but does not contain a fluorine-containing phosphate ester. In Comparative Example 3, there was used an electrolytic solution that contains a fluorine-containing phosphate ester but does not contain a cyclic sulfonate ester.

In Comparative Example 2, by adding cyclic disulfonate ester to the electrolytic solution, the capacity retention ratio was hardly changed compared with Comparative Example 1 while the amount of gas generation was increased. Moreover, by adding PTTFE to the electrolytic solution in Comparative Example 3, the amount of gas generation was largely lowered compared with Comparative Example 1 while a decrease in capacity was remarkable. By contrast, in the Example 1, by adding cyclic disulfonate ester and PTTFE, the amount of gas generation was decreased as much as in Comparative example 3, and the capacity retention ratio was much more improved than in any of Comparative Examples 1, 2 and 3. That is, when both the cyclic disulfonate ester and fluorine-containing phosphate ester were added, the effects of improving the capacity retention ratio and of suppressing the amount of gas generation showed a much better result than the case where either one of them was added.

### Example 2

A cyclic monosulfonate ester (propanesultone) was added in an amount of 3 wt % to a solvent in which EC, PTTFE, and TFETFPE were mixed (volume ratio: EC/PTTFE/TFETFPE=3/5/2) as a nonaqueous electrolytic solvent. The volume ratio of PTTFE is 50%. A secondary battery was produced in the same manner as in Example 1 except for using this solvent. The capacity retention ratio after 45° C. 300 cycles was 61%, and the amount of gas generation in 45° C. 200 cycles was 0.5 cc.

### Comparative Example 4

A secondary battery was produced in the same manner as in Example 2 except for using the above-mentioned EC/PTTFE/TFETFPE (volume ratio: EC/PTTFE/TFETFPE=3/5/2) as a nonaqueous electrolytic solvent and for adding no additive (cyclic sulfonate ester). The capacity retention ratio after 45° C. 300 cycles was 51%, and the amount of gas generation in 45° C. 200 cycles was 0.5 cc.

In Example 2, also in the case where propanesultone (PS) was used as an additive, it was possible to improve the retention ratio while keeping the amount of gas generation unchanged.)

### Example 3

A cyclic disulfonate ester (1,5,2,4-dioxadithiane-2,2,4,4-tetraoxide) was added in an amount of 0.57 wt % to a solvent in which EC, propylene carbonate (PC), PTTFE and TFETFPE were mixed (volume ratio: EC/PC/PTTFE/TFETFPE=3/1/4/2) as a nonaqueous electrolytic solvent. The volume percentage of PTTFE is 40%. A secondary battery was produced in the same manner as in Example 1 except for using this solvent. The capacity retention ratio after 20° C. 500 cycles was 77%, and the amount of gas generation in 45° C. 200 cycles was 0.2 cc.

### Example 4

A cyclic disulfonate ester (1,5,2,4-dioxadithiane-2,2,4,4-tetraoxide) was added in an amount of 0.8 wt % to a solvent in which EC, PC, PTTFE and TFETFPE were mixed (volume ratio: EC/PC/PTTFE/TFETFPE=2/1/2/5) as a nonaqueous electrolytic solvent. The volume percentage of PTTFE is 20%. LiPF₆ was dissolved in a concentration of 0.8 mol/l into this nonaqueous electrolytic solvent. A secondary battery was produced in the same manner as in Example 1 except for using this solvent. The capacity retention ratio after 20° C. 200 cycles was 83%, and the amount of gas generation in 45° C. 100 cycles was 0.03 cc.

In Examples 3 and 4 in which PC was used instead of DMC as a nonaqueous electrolytic solvent of the electrolytic solution and the composition ratio was changed, the amount of gas generation was suppressed and the capacity retention ratio were good values.

The above-mentioned results show that the electrolytic solution of the present embodiment is suitable for a high voltage of 4.6 V or more, and it is suggested that the electrolytic solution of the present embodiment is also effective in positive electrode materials of LiCoPO₄, Li(Co_{0.5}Mn_{0.5})O₂, Li(Li_{0.2}Mo_{0.3}Mn_{0.5}O₂ and the like, which show an equivalent potential.

### EXPLANATION OF SYMBOLS

1 Positive electrode active material layer
2 Negative electrode active material layer
3 Positive electrode current collector
4 Negative electrode current collector
5 Separator
6 Laminate outer package
7 Laminate outer package
8 Negative electrode tab
9 Positive electrode tab

1. A lithium secondary battery comprising:
a positive electrode comprising a positive electrode active material; and an electrolytic solution comprising a nonaqueous electrolytic solvent,
wherein
the positive electrode active material operates at a potential of 4.5 V or more versus lithium, and
the electrolytic solution comprises: the nonaqueous electrolytic solvent comprising a fluorine-containing phosphate ester represented by the following formula (1); and a cyclic sulfonate ester represented by the following formula (2): 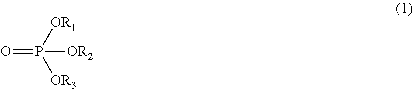
wherein R₁, R₂ and R₃ are each independently substituted or unsubstituted alkyl group, and at least one of R₁, R₂ and R₃ is fluorine-containing alkyl group; and 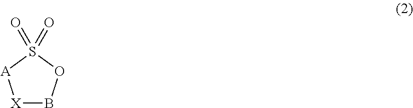
wherein A and B are each independently alkylene group or fluoroalkylene group, and X is a C—C single bond or —OSO₂— group.

2. The lithium secondary battery according to claim 1, wherein a content of the fluorine-containing phosphate ester is 5 volume % or more and 95 volume % or less in the nonaqueous electrolytic solvent.

3. The lithium secondary battery according to claim 1, wherein at least one of R₁, R₂ and R₃ is fluorine-containing alkyl group in which 50% or more of hydrogen atoms contained in corresponding unsubstituted alkyl group are replaced with fluorine atoms.

4. The lithium secondary battery according to claim 1, wherein the fluorine-containing phosphate ester is a compound represented by the following formula (3):

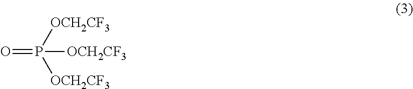

5. The lithium secondary battery according to claim 1, wherein the cyclic sulfonate ester contains a cyclic sulfonate ester represented by the following formula (4) and/or the following formula (5): 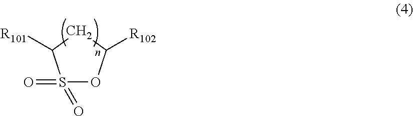
wherein R₁₀₁ and R₁₀₂ each independently denote a hydrogen atom, a fluorine atom, or alkyl group having 1 to 4 carbon atoms; and n is 0, 1, 2, 3 or 4; and 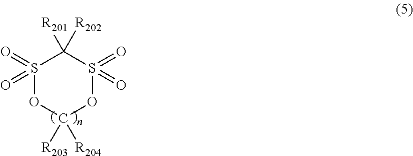
wherein R₂₀₁ to R₂₀₄ each independently denote a hydrogen atom, a fluorine atom, or alkyl group having 1 to 4 carbon atoms; n is 1, 2, 3 or 4; and when n is 2, 3 or 4, R₂₀₃ in n-occurrences may be the same or different from each other, and R₂₀₄ in n-occurrences may be the same or different from each other.

6. The lithium secondary battery according to claim 1, wherein a content of the cyclic sulfonate ester in the electrolytic solution is 0.01 to 10 mass %.

7. The lithium secondary battery according to claim 1, wherein the positive electrode active material contains a lithium manganese composite oxide represented by the following formula (6):
Liₐ(MₓMn_{2-x-y}Y_{y})(O_{4-w}Z_{w}) (6)
wherein 0.5≦x≦1.2, 0≦y, x+y<2, 0≦a≦1.2, 0≦w≦1; M is at least one selected from the group consisting of Co, Ni, Fe, Cr and Cu; Y is at least one selected from the group consisting of Li, B, Na, Al, Mg, Ti, Si, K and Ca; and Z is at least one selected from the group consisting of F and Cl.

8. The lithium secondary battery according to claim 1, wherein the positive electrode active material contains a lithium metal composite oxide represented by the following formula (7), (8), or (9):
LiMPO₄ (7)
wherein M is at least one of Co and Ni;
Li(M_{1-z}Mn_{z})O₂ (8)
wherein 0.7≧z≧0.33, and M is at least one of Li, Co and Ni;
Li(LiₓM_{1-x-z}Mn_{z})O₂ (9)
wherein 0.3>x≧0.1, 0.7≧z≧0.33, and M is at least one of Co and Ni.

9. The lithium secondary battery according to claim 1, wherein the nonaqueous electrolytic solvent contains a cyclic carbonate and/or a chain carbonate.

10. The lithium secondary battery according to claim 1, wherein the nonaqueous electrolytic solvent contains a fluorinated chain ether represented by the following formula (10):
CₙH₂ₙ₊₁₋ₗFₗ—O—CₘH₂ₘ₊₁₋ₖFₖ (10)
wherein n is 1, 2, 3, 4, 5 or 6; m is 1, 2, 3 or 4; l is any integer from 0 to 2n+1; k is any integer from 0 to 2m+1; and at least one of l and k is an integer of 1 or more.
